(19) United States
(12) Patent Application Publication
(10) Pub. No.: US 2008/0198827 A1
(43) Pub. Date: Aug. 21, 2008

(54) SYSTEM FOR SHARING CABLING IN A BUILDING

(75) Inventor: ASSAD RADPOUR, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/677,542

(22) Filed: Feb. 21, 2007

(51) Int. Cl. H04J 1/00

(52) U.S. Cl. 370/339

(57) ABSTRACT

A system for sharing cabling in a building is disclosed. An apparatus that incorporates teachings of the present disclosure may include, for example, a converter having a plurality of connectors and corresponding processing elements for coupling to a wireless transceiver and a coaxial cable that traverses a building, wherein the converter supplies power to the wireless transceiver which provides by way of the coaxial cable communication connectivity to one or more computing devices housed in the building. Additional embodiments are disclosed.

### FIELD OF THE DISCLOSURE

The present disclosure relates generally to cabling methods, and more specifically to a system for sharing cabling in a building.

### BACKGROUND

Telecommunication service providers are often upgrading services to its consumers. In areas where a residence or commercial enterprise is hard to reach by landlines or far from a central office, some service providers have resorted to deploying fixed wireless access technologies to provide broadband services at the residence or commercial enterprise. In such situations, field technicians are often required to drill one or more holes into an outside wall of a building to connect a wireless transceiver to cabling used for distributing communication services in the building. Such work is time consuming and costly to service providers, and undesirably intrusive for some customers.

A need therefore arises for a system for sharing cabling in a building.

### BRIEF DESCRIPTION OF THE DRAWINGS

FIG. 1 depicts an exemplary embodiment of a communication system; and

FIGS. 2-3 depict exemplary embodiments for coupling a wireless transceiver of the communication system to a building.

### DETAILED DESCRIPTION

Embodiments in accordance with the present disclosure provide a system for sharing cabling in a building.

In a first embodiment of the present disclosure, an outdoor converter can have a first coaxial cable connector for coupling to a first coaxial cable that traverses from an outside portion to an inside portion of a building, a modular connector for coupling to a wireless transceiver, a Low Pass Filter (LPF) coupled to the first coaxial cable connector for extracting a DC power signal from the first coaxial cable and for directing said DC power signal to the wireless transceiver by way of the modular connector, a first translator element coupled to the first coaxial cable connector for selectively generating from one or more signals in the first coaxial cable a first signal operating at a first frequency directed to the wireless transceiver by way of the modular connector, and a mixer coupled to the modular connector for modulating a second signal received from the wireless transceiver operating at a second frequency and for generating a third signal operating at a third frequency directed to the first coaxial cable by way of the first coaxial cable connector.

In a second embodiment of the present disclosure, an indoor converter can have a first coaxial cable connector for coupling to a first coaxial cable that traverses from an inside portion to an outside portion of a building, a modular connector for coupling to one or more communication devices and a power source in the building, a first translator element for coupling to the first coaxial cable connector for selectively generating from one or more signals in the first coaxial cable a first signal operating at a first frequency that is directed to the one or more communication devices by way of the modular connector, a mixer coupled to the modular connector that modulates a second signal received from the one or more communication devices operating at a second frequency and generates a third signal operating at a third frequency, and a summer coupled to the modular connector and the mixer for generating a summed signal comprising the third signal and a DC signal supplied by the modular connector, wherein the summed signal is directed to the first coaxial cable by way of the first coaxial cable connector.

In a third embodiment of the present disclosure, a converter can have a plurality of connectors and corresponding processing elements for coupling to a wireless transceiver and a coaxial cable that traverses a building. The converter can supply power to the wireless transceiver which in turn provides by way of the coaxial cable communication connectivity to one or more computing devices housed in the building.

In a fourth embodiment of the present disclosure, a power injection device can have an AC to DC converter coupled to an AC power source that generates a DC signal from said AC power source, a first modular connector that couples to one or more communication devices, and a second modular connector that couples to the first modular connector, the AC to DC converter and an indoor converter, thereby supplying to said indoor converter the DC signal and establishing connectivity between the one or more communication devices and said indoor converter. The indoor converter can have a first coaxial cable connector coupled to a first coaxial cable that traverses from an inside portion to an outside portion of a building housing the power injection device and the indoor converter, a third modular connector coupled to the second modular connector for connecting to the one or more communication devices and the DC signal, a translator element coupled to the first coaxial cable connector that selectively generates from one or more signals in the first coaxial cable a first signal operating at a first frequency that is connected to the one or more communication devices by way of the third modular connector, a mixer coupled to the third modular connector that modulates a second signal received from the one or more communication devices operating at a second frequency and generates a third signal operating at a third frequency, and a summer coupled to the third modular connector and the mixer for generating a summed signal comprising the third signal and the DC signal, wherein the summed signal is connected to the first coaxial cable by way of the first coaxial cable connector.

In a fifth embodiment of the present disclosure, a communication device, can have a wireless transceiver for coupling to a converter that couples to a coaxial cable that traverses a building, wherein the converter supplies power to the wireless transceiver which provides by way of the coaxial cable communication connectivity to one or more computing devices housed in the building, and a controller that manages operations of the wireless transceiver.

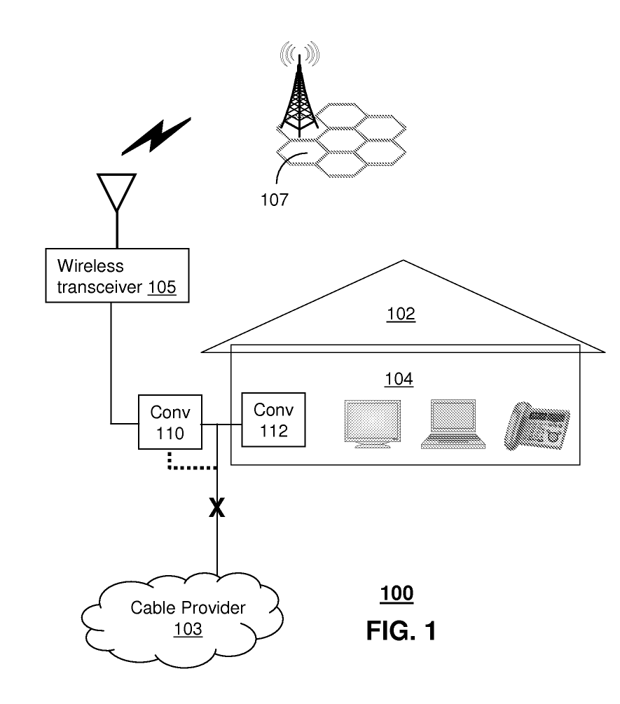

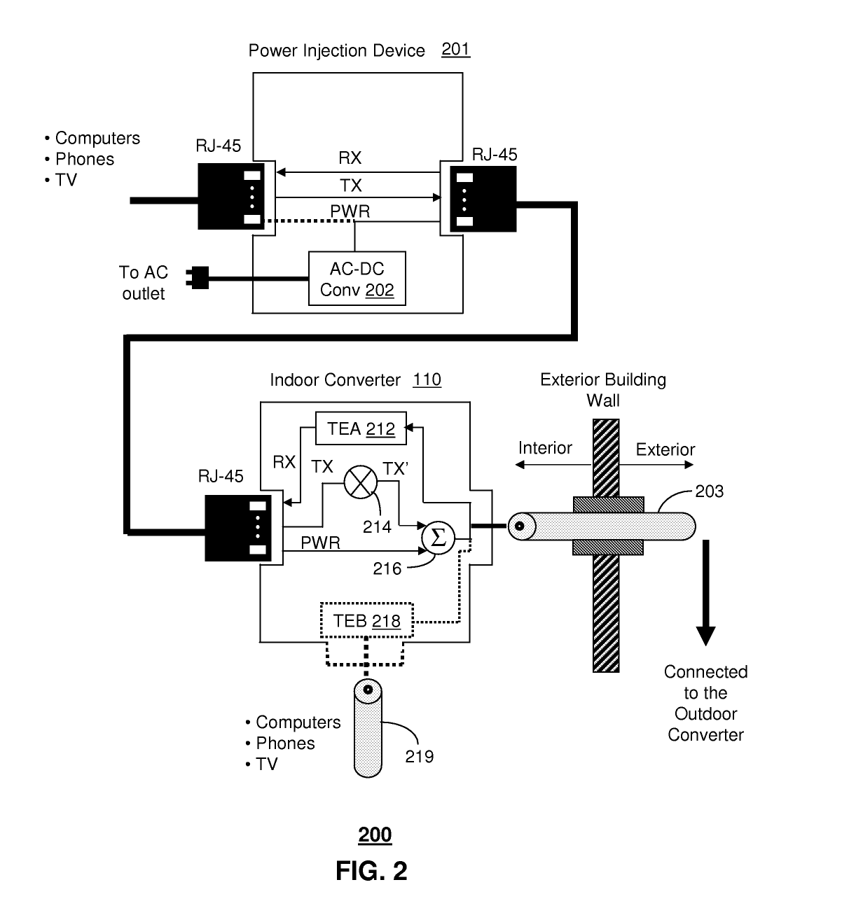

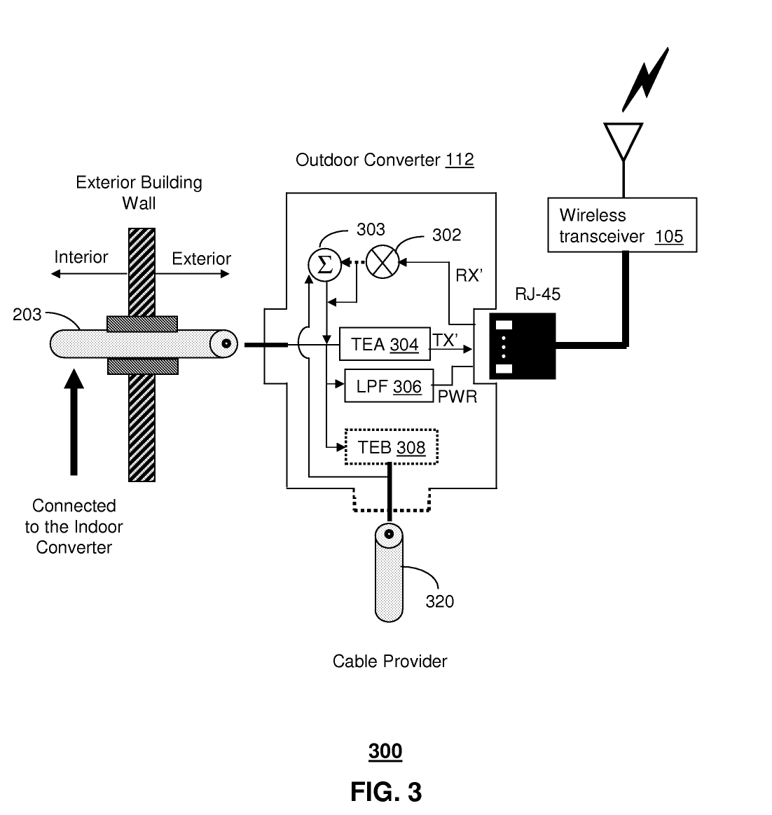

FIG. 1 depicts an exemplary embodiment of a communication system 100. The communication system 100 can comprise a wireless transceiver 105 that can share (indicated by the cut-off point shown in FIG. 1) a coaxial cable interface (shown as converters 110, 112—see FIGS. 2-3) to a building 102 such as a residence or commercial enterprise with a cable service provider 103 for communicating with one or more communication devices 104 in said building. Alternatively, if an extra unused coaxial cable is available into the building 102, the wireless transceiver 105 can be coupled to said building without affecting existing connections to the cable provider 103 by way of the same converters 110, 112.

The wireless transceiver 105 can exchange wireless messages with a wireless base station 107 that operates according to a frequency reuse plan. The wireless transceiver 105 and base station 107 can exchange messages according to any number of access technologies including without limitation Worldwide Interoperability for Microwave Access (WiMAX), Ultra Wide Band (UWB), or common cellular access technologies such as GSM, CDMA, and UMTS, just to name a few. Additionally, Software Defined Radio (SDR) can be used by the wireless transceiver 105 as a technique to define any of the aforementioned access technologies or future generation access technologies as they arise.

FIGS. 2-3 depict exemplary embodiments for coupling the wireless transceiver 105 to the building 102. Referring to FIG. 2, the inside of the building 102 can comprise a power injection device 201 coupled to an indoor converter 110 for exposing communication lines of the wireless transceiver 105 inside the building. This can be accomplished by utilizing a coaxial cable 203 that traverses from an inside portion to an outside portion of the building 102. To communicate with the communication devices 104 in the building, the wireless transceiver 105 needs three sets of signals: transmit (signal generated by the wireless transceiver and directed to communication devices), receive (signal generated by the communication devices and directed to wireless transceiver) and a power source from within the building.

The transmit (TX) and receive (RX) signals can be carried on wired pairs (e.g., twisted pair for TX and twisted pair for RX) by way of an RJ-45 connector-cable shown on the left hand portion of the power injection device 201 directed to the communication devices 104 by way of a cable distribution designed into the building 102. An RJ-45 connector-cable (shown on the right hand side of the power injection device 201) can be used to carry the wired pairs of TX, RX and power to the wireless transceiver 105 by way of the indoor converter 110. To provide power to the wireless transceiver 105, the power injection device 201 can utilize a common AC to DC converter 202 that converts a common AC signal to a DC signal (e.g., 12 Volts or other desired voltage level).

Note the left hand RJ-45 connector-cable of the power injection device 201 does not carry power to the communication devices 104. This is the exclusive function of the right hand RJ-45 connector-cable. It can be appreciated though that in the future some communication devices 104 can be designed to derive power from an RJ-45 cable distribution in the building. In this case, the power injection device 201 can be designed to supply power to both the left and right RJ-45 jacks.

The indoor converter 110 performs a conversion process on the TX, RX and PWR signals it receives from the power injection device so that said signals can be carried by the coaxial cable 203 to the wireless transceiver 105 by way of an outdoor converter 112 (see FIG. 3) without having to drill additional holes into the building 102, thereby saving a field technician the time and expense of making modifications to the building structure. The indoor converter 110 performs two processing techniques on the RX and TX lines. In the case of the RX line, the indoor converter 110 applies a first translator element (TEA) 212 to signals received from the coaxial cable 203 traversing the building 102. The TEA 212 extracts the RX signal supplied by the outdoor converter 112 utilizing any one of a number of common signal extraction techniques.

In one embodiment the TEA 212 can correspond to a bandpass filter that filters out undesired signals outside of a desired band in which the RX signal is carried by the coaxial cable 203. The extracted RX signal is then supplied to the communication devices 104 by way of the RJ-45 connector cable connecting the indoor converter 110 to the power injection device 201. Alternatively, the TEA 212 can represent a common demodulator that performs a demodulation process applying, for example, a corresponding mixer on signals received from the coaxial cable 203, thereby generating the RX signal at a given operating frequency (e.g., baseband or otherwise). In each of the above examples, the RX signal carried by the coaxial cable 203 can be modulated by the outdoor converter 112 at a known frequency and injected into the coaxial cable 203. The TEA 212 then performs the extraction according to one of the aforementioned methods.

To carry the TX signal on the coaxial cable 203, the TX signal received from the power injection device 201 is modulated by a common mixer 214 to a desired carrier frequency. The modulated TX signal (TX′) is then combined with the power signal (PWR) with a common summer 216 and the summed signal is applied to the coaxial cable 203. The summer 216 can be designed to limit undesired feedback into mixer 214. It should be noted that the TEA 212 and the mixer 214 of the indoor converter 110 can be powered by the power signal (PWR) supplied by the power injection device 201 over the RJ-45 connector-cable.

Referring to FIG. 3, the outdoor converter 112 connects to the coaxial cable 203. Through this connection, the outdoor converter 112 extracts the TX signal utilizing a first translator element (TEA) 304 (similar to the one used by the indoor converter 110). Thus the TEA 304 can represent a bandpass filter or a common demodulator for extracting the TX in a similar manner in which the RX signal is extracted by the indoor converter 110. The RX signal generated by the wireless transceiver 105 can be modulated by a common mixer 302 similar to the one used by the indoor converter 110 for modulating the TX signal. To provide a clean power signal to the wireless transceiver 105 and the TEA 304 and mixer 302, the outdoor converter 112 can employ a common low pass filter (LPF) that substantially removes signals above DC.

The exemplary embodiments described above for the indoor and outdoor converters 110, 112 can be applied in situations where the coaxial cable 203 traversing the exterior wall of the building 102 can be utilized without impacting other services provided to said building on the same cable system. For example, in some situations, buildings are designed with redundant cabling in which case an extra external coaxial cable can be used by a service provider without affecting other services such as cable services from the cable service provider 103 referred to in FIG. 1. In situations, however, in which there is no redundant cabling and a consumer would desire to derive services in part from the cable service provider 103 and the service provider installing the wireless transceiver 105, the indoor and outdoor converters 110, 112 can be supplemented with additional functionality to share the coaxial cable 203 with more than one service provider.

In this embodiment, the outdoor converter 112 can comprise a second translator element (TEB) 308 which can be used to filter out the TX, RX and PWR signals injected by the outdoor and indoor converters 110, 112. The TEB 308 can be represented by a common bandpass filter that filters said signals at a band in which the cable provider's signals are known to operate. The signals carried by a coaxial cable 320 of the cable provider can be re-injected into the building's coaxial cable 203 by way of a summer 303 with the modulated RX signal generated by mixer 302. The summer 303 can be designed to limit undesired feedback into mixer 302. Referring back to FIG. 2, the indoor converter 110 can also include a second translator element (TEB) 218 which filters all signals except those associated with the cable providers services in a similar manner to TEB 308 of the outside converter 112. The TEB 218 can in this embodiment also represent a bandpass filter that performs said function. The extracted signals are then fed to a coaxial cable 219 that is distributed throughout the building for access by the communication devices 104.

Upon reviewing the aforementioned embodiments, it would be evident to an artisan with ordinary skill in the art that said embodiments can be modified, reduced, or enhanced without departing from the scope and spirit of the claims described below. For example, given the commonality in components between the indoor and outdoor converters 110, 112, said converters can be integrated into a single unit by including a programmable switch (e.g., a dip switch) and a low pass filter that can reconfigure said converter as either an indoor or outdoor converter. Said modification can save manufacturing costs and can provide additional time-savings for installation. This is but one example of modifications that can be applied to the present disclosure without affecting the scope of said disclosure as defined by the claims below. Accordingly, the reader is directed to the claims section for a fuller understanding of the breadth and scope of the present disclosure.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A converter, comprising:
a first coaxial cable connector for coupling to a first coaxial cable that traverses from an outside portion to an inside portion of a building;
a modular connector for coupling to a wireless transceiver;
a Low Pass Filter (LPF) coupled to the first coaxial cable connector for extracting a DC power signal from the first coaxial cable and for directing said DC power signal to the wireless transceiver by way of the modular connector;
a first translator element coupled to the first coaxial cable connector for selectively generating from one or more signals in the first coaxial cable a first signal operating at a first frequency directed to the wireless transceiver by way of the modular connector; and
a mixer coupled to the modular connector for modulating a second signal received from the wireless transceiver operating at a second frequency and for generating a third signal operating at a third frequency directed to the first coaxial cable by way of the first coaxial cable connector.

2. The converter of claim 1, wherein the first translator element comprises a Bandpass Filter (BPF) that filters unwanted signals from the first coaxial cable and generates the first signal operating at the first operating frequency.

3. The converter of claim 1, wherein the first translator element comprises a demodulator that performs demodulation on one or more signals received from the first coaxial cable, thereby generating the first signal operating at the first operating frequency.

4. The converter of claim 1, wherein the first operating frequency corresponds to an original operating frequency of the first signal prior to its modulation by an external source.

5. The converter of claim 1, wherein the modular connector comprises a Registered Jack (RJ) 45 connector.

6. The converter of claim 1, wherein the first coaxial cable connector comprises a Bayonet-Neill-Concelman (BNC) connector.

7. The converter of claim 1, wherein the wireless transceiver conforms to a Worldwide Interoperability for Microwave Access (WiMAX) communications protocol.

8. The converter of claim 1, wherein the building corresponds to one among a commercial enterprise and a residence.

9. The converter of claim 1, comprising:
a second coaxial cable connector for coupling to a second coaxial cable managed by a service provider; and
a second translator element coupled to the first coaxial cable connector for generating one or more filtered signals that exclude the DC power signal of the first coaxial cable, wherein said one or more filtered signals are directed to the second coaxial cable by way of the second coaxial cable connector.

10. The converter of claim 9, comprising a summer for coupling to the second coaxial cable connector that sums the second signal generated by the mixer with one or more signals supplied by the second coaxial cable to generate a third signal directed to the first coaxial cable.

11. A converter, comprising:
a first coaxial cable connector for coupling to a first coaxial cable that traverses from an inside portion to an outside portion of a building;
a modular connector for coupling to one or more communication devices and a power source in the building;
a first translator element for coupling to the first coaxial cable connector for selectively generating from one or more signals in the first coaxial cable a first signal operating at a first frequency that is directed to the one or more communication devices by way of the modular connector;
a mixer coupled to the modular connector that modulates a second signal received from the one or more communication devices operating at a second frequency and generates a third signal operating at a third frequency; and
a summer coupled to the modular connector and the mixer for generating a summed signal comprising the third signal and a DC signal supplied by the modular connector, wherein the summed signal is directed to the first coaxial cable by way of the first coaxial cable connector.

12. The converter of claim 11, wherein the first translator element comprises a Bandpass Filter (BPF) that filters unwanted signals from the first coaxial cable and generates the first signal operating at the first operating frequency.

13. The converter of claim 11, wherein the first translator element comprises a demodulator that performs demodulation on one or more signals received from the first coaxial cable, thereby generating the first signal operating at the first operating frequency.

14. The converter of claim 11, wherein the first operating frequency corresponds to an original operating frequency of the first signal prior to its modulation by an external source.

15. The converter of claim 11, wherein the modular connector comprises a Registered Jack (RJ) 45 connector.

16. The converter of claim 11, wherein the first coaxial cable connector comprises a Bayonet-Neill-Concelman (BNC) connector.

17. The converter of claim 11, comprising:
a second coaxial cable connector for coupling to a second coaxial cable that supplies cable services to one or more devices in the building; and
a second translator element for coupling to the first coaxial cable connector that generates one or more filtered signals that exclude the DC power signal of the first coaxial cable, wherein said one or more filtered signals are directed to the second coaxial cable by way of the second coaxial cable connector.

18. A converter, comprising a plurality of connectors and corresponding processing elements for coupling to a wireless transceiver and a coaxial cable that traverses a building, wherein the converter supplies power to the wireless transceiver which provides by way of the coaxial cable communication connectivity to one or more computing devices housed in the building.

19. The converter of claim 18, wherein the converter comprises:
a coaxial cable connector for coupling to the coaxial cable;
a modular connector for coupling to a wireless transceiver;
a Low Pass Filter (LPF) coupled to the coaxial cable connector for extracting a DC power signal from the coaxial cable and for directing said DC power signal to the wireless transceiver by way of the modular connector;
a translator element coupled to the coaxial cable connector for selectively generating from one or more signals in the coaxial cable a first signal operating at a first frequency directed to the wireless transceiver by way of the modular connector; and
a mixer coupled to the modular connector for modulating a second signal received from the wireless transceiver operating at a second frequency and for generating a third signal operating at a third frequency directed to the coaxial cable by way of the coaxial cable connector.

20. The converter of claim 19, wherein the translator element comprises one among a Bandpass Filter (BPF) that filters unwanted signals from the coaxial cable and generates the first signal operating at the first operating frequency, and a demodulator that performs demodulation on one or more signals received from the coaxial cable, thereby generating the first signal operating at the first operating frequency, wherein the modular connector comprises a Registered Jack (RJ) 45 connector, wherein the coaxial cable connector comprises a Bayonet-Neill-Concelman (BNC) connector, and wherein the wireless transceiver operates according to a Worldwide Interoperability for Microwave Access (WiMAX) communications protocol.
